(19) United States
(12) Patent Application Publication
(10) Pub. No.: US 2008/0074742 A1
(43) Pub. Date: Mar. 27, 2008

(54) Lenticular lens type three dimensional image display device and method of fabricating the same

(75) Inventors: Hyeok-Soo Kim, Gyeongsangbuk-do (KR); Hoon Kang, Gumi-si (KR)

Correspondence Address: MORGAN LEWIS & BOCKIUS LLP, 1111 PENNSYLVANIA AVENUE NW, WASHINGTON, DC, 20004, US

(73) Assignee: LG.Philips LCD Co., Ltd.

(21) Appl. No.: 11/898,992

(22) Filed: Sep. 18, 2007

(30) Foreign Application Priority Data
Sep. 25, 2006 (KR) 2006-0092744

(51) Int. Cl. H04N 13/00; B29D 11/00

(52) U.S. Cl. 359/463; 264/1.38

(57) ABSTRACT

A lenticular lens type three-dimensional image display device comprises a display panel; a first polarizer on an upper surface of the display panel; a glue layer uniformly formed on an entire surface of the first polarizer; and a lenticular lens sheet on the glue layer, wherein the glue layer has an adhesive property when exposed to an ultraviolet light.

The present application claims the benefit of Korean Patent Application No. 2006-0092744 filed in Korea on Sep. 25, 2006, which is hereby incorporated by reference.

### BACKGROUND OF THE INVENTION

1. Field of the Invention

The present invention relates to a lenticular lens type three dimensional image display device, and more particularly, to a lenticular lens type three dimensional image display device having a lenticular lens sheet and a method of fabricating the lenticular lens type three dimensional image display device.

2. Discussion of the Related Art

A technology of producing three dimensional (3-D) images including 3-D stereoscopic images from two dimensional (2-D) images can be used in display technologies, aerospace technologies, etc. The technology using ripple effects to produce 3-D images can not only be used in applications for high definition televisions (HDTV), but also can be used in a variety of other applications.

The technology of producing 3-D stereoscopic images includes a volumetric type, a holographic type, and stereoscopic type. The volumetric type uses psychological illusions to create illusory perception along a depth direction. When observers receive 3-D computer graphical images on a large screen having a wide view angle, the observers can experience viewing an optical illusion. By calculating and implementing various factors in 3-D computer graphics technology, images can be displayed to give the observers a 3-D effect on movement, brightness, shade, etc. An example of this kind of volumetric type of display is an IMAX™ movie. In an IMAX™ movie, two camera lenses are used to represent images for the left and right eyes. The two lenses are separated by an average distance between a human's eyes. By recording images on two separate rolls of film for the left and right eyes, and then projecting them simultaneously, the viewers can be tricked into seeing a 3D image on a 2D screen. The holographic type is known to be the most remarkable technology for displaying 3-D stereoscopic images. The holographic type can be further divided depending on the light source that is used. For example, there are holographic displays using laser and holographic displays using white light. The stereoscopic type uses psychological effects to create 3-D images. In normal vision, human eyes perceive views of the world from two different perspectives due to the spatial separation of two eyes. The spatial separation between typical eyes is about 65 mm. In order to assess the distance between objects, the brain integrates the two images obtained from each eye. By integrating two images, we are able to perceive 3-D images. The above method of perceiving a 3-D image is referred to as a stereograpy phenomenon. The stereoscopic type can be divided into a glasses type and a glasses-free type depending on whether glasses are adopted. The glasses-free type uses a parallax barrier, a lenticular lens array, or an integral lens array, etc. Among these, the lenticular lens array is widely under research today since observers can see 3-D images simply by disposing a lenticular lens on a display panel without any other equipment.

FIG. 1 is view explaining principle of displaying images in a lenticular lens type 3-D image display device according to the related art. As shown in FIG. 1, the lenticular lens type 3-D image display device 10 includes a display panel 12 and a lenticular lens sheet 14. The display panel 12 displays the 2-D images for both left and right eyes. The lenticular lens sheet 14 assigns different viewing zones for the 2-D images according to the left and right eyes, respectively.

The display panel 12 is a flat panel display (FPD) device, examples of which include a cathode ray tube (CRT), a liquid crystal display (LCD) device, an organic light emitting display (OLED) device, a plasma display panel (PDP), and a field emission display (FED) device. First and second red pixels R_{R} and R_{L}, first and second green pixels G_{R} and G_{L}, and first and second blue pixels B_{R} and B_{L} are alternately arranged on the display panel 12. The first red pixel. R_{R}, the first green pixel G_{R} and the first blue pixel B_{R} display images for the right eye, and the second red pixel R_{L}, the second green pixel G_{L} and the second blue pixel B_{L} display images for the left eye. The lenticular lens sheet 14 includes a lenticular lens. The lenticular lens has a half-cylinder shape and is regularly arranged.

The 2-D images emitted from the display panel 12 pass through the lenticular lens sheet 14 to reach the left and right eyes of an observer. The brain integrates the 2-D images obtained from each eye to perceive a 3-D image. In the above-mentioned lenticular lens type 3-D image display device, one observer in one direction to the lenticular lens sheet 14 can perceive images.

Another one of the conventional lenticular lens type 3-D image display device, where at least two observes at different locations can perceive images from the lenticular lens type 3-D image display device. It is referred to as a multi-view points lenticular lens type 3-D image display device.

FIG. 2 shows the conventional multi-view points lenticluar type 3-D image display device. In FIG. 2, observes 1, 2 and 3 in three viewpoints can perceive images from the multi-view points lenticluar type 3-D image display device 20. The multi-view points lenticluar type 3-D image display device 20 includes a display panel 22 and a lenticular lens sheet 24. The display panel 22 displays the 2-D images from both left and right eyes. The lenticular lens has a half-cylinder shape and is regularly arranged.

First to fourth red pixels R1, R2, R3 and R4, first to fourth green pixels G1, G2, G3 and G4, and first to fourth blue pixels B1, B2, B3 and B4 are alternately arranged on the display panel 22. Two of the first to fourth red pixels R1, R2, R3 and R4, two of the first to fourth green pixels G1, G2, G3 and G4, and two of the first to fourth blue pixels B1, B2, B3 and B4 display images for the right eye, and the other two of the first to fourth red pixels R1, R2, R3 and R4, the other two of the first to fourth green pixels G1, G2, G3 and G4, and the other two of the first to fourth blue pixels B1, B2, B3 and B4 display images for the left eye. The first red pixel R1, the first green pixel G1 and the first blue pixel B1 display images for the right eye of a first observer 1 at a first viewpoint, and the second red pixel R2, the second green pixel G2 and the second blue pixel B2 display images for the left eye of the first observer 1 at the first viewpoint. The third red pixel R3, the third green pixel G3 and the third blue pixel B3 display images for the right eye of a second observer 2 at a second viewpoint, and the fourth red pixel R4, the fourth green pixel 64 and the fourth blue pixel B4 display images for the left eye of the second observer 1 at the second viewpoint. The first red pixel R1, the first green pixel G1 and the first blue pixel B1 display images for the right eye of a third observer 3 at a third viewpoint, and the second red pixel R2, the second green pixel G2 and the second blue pixel B2 display images for the left eye of the third observer 1 at the third viewpoint.

In the above two lenticular lens type 3-D image display devices, a relative position between the lenticular lens sheet and the display panel is very important so as to assigns different viewing zones according to the left and right eyes. The lenticular lens sheet may align on and fixed to the display panel. The lenticular lens sheet aligns on the display panel and fixed to the display panel using a frame of a rectangular shape. The frame covers edge portions and side portions of the lenticular lens sheet and the display panel.

However, there are some problems for displaying desired images. The above structure is not everlasting. Moreover, the above structure may be distorted because of an external impact.

### SUMMARY OF THE INVENTION

Accordingly, the present invention is directed to a lenticular lens type 3-D image display device and a method of fabricating the same that substantially obviates one or more problems due to limitations and disadvantages of the related art.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described, a lenticular lens type three-dimensional image display device comprises a display panel; a first polarizer on an upper surface of the display panel; a glue layer uniformly formed on an entire surface of the first polarizer; and a lenticular lens sheet on the glue layer, wherein the glue layer has an adhesive property when exposed to an ultraviolet light.

In another aspect, a method of fabricating a lenticular lens type three-dimensional image display device comprises uniformly forming a material layer on an entire surface of a display panel; disposing a lenticular lens sheet on the material layer; and irradiating an ultraviolet light onto the material layer through the lenticular lens sheet, the lenticular lens sheet fixed to the display panel.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention. In the drawings:

FIG. 1 is view explaining principle of displaying images in a lenticular lens type 3-D image display device according to the related art.

FIG. 2 shows the conventional multi-view points lenticluar type 3-D image display device.

FIG. 3 is a schematic cross-sectional view of a lenticular lens type 3-D image display device according to the present invention.

FIGS. 4A to 4E are cross-sectional views showing a process of fabricating a lenticular lens type 3-D image display device according to the present invention.

FIG. 5 is a schematic cross-sectional view showing a liquid crystal panel used for a display panel in a lenticular lens type 3-D image display device according to the present invention.

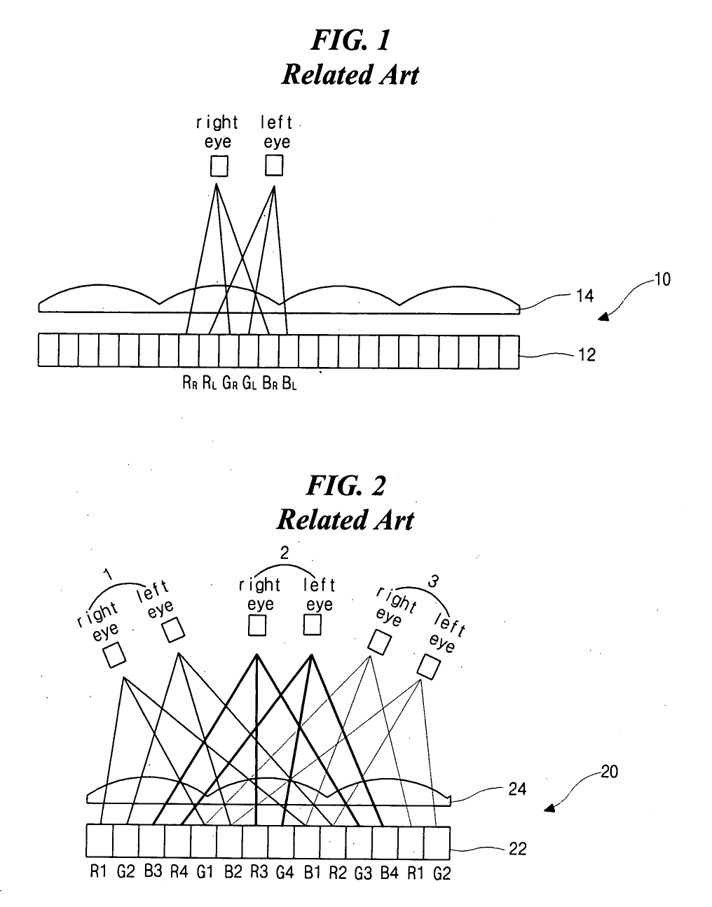

### DETAILED DESCRIPTION OF THE PREFERRED EMBODIMENTS

Reference will now be made in detail to the preferred embodiments of the present invention, examples of which are illustrated in the accompanying drawings.

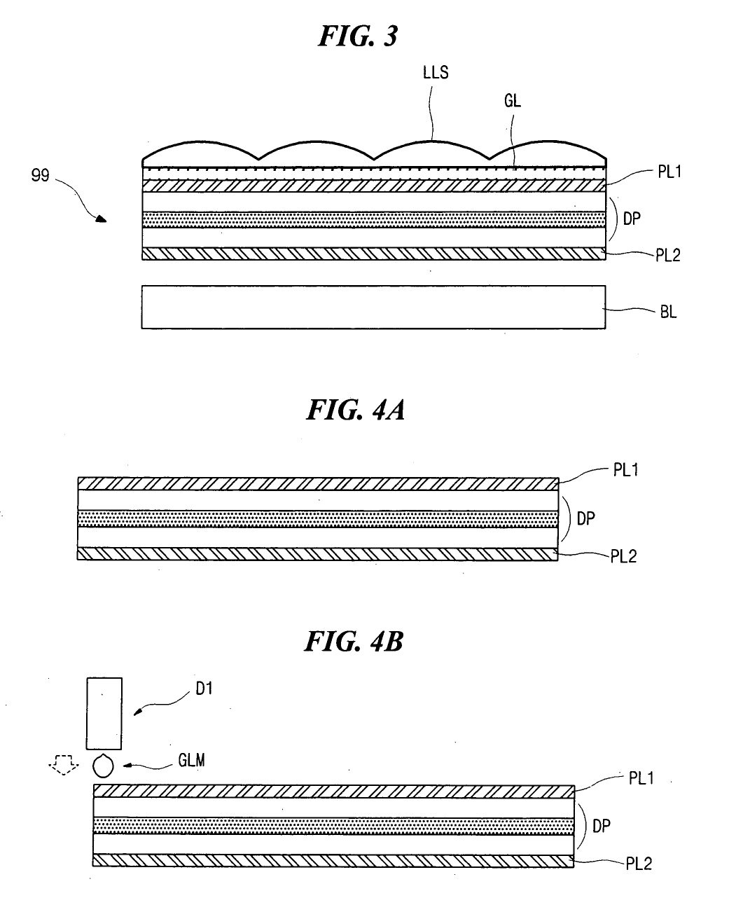

FIG. 3 is a schematic cross-sectional view of a lenticular lens type 3-D image display device according to the present invention. In the lenticular lens type 3-D image display device according to the present invention, a display panel is explained as a liquid crystal (LC) panel.

In FIG. 3, the lenticular lens type 3-D image display device 99 according to the present invention includes a LC panel DP, a backlight unit BL and a lenticular lens sheet LLS. The LC panel DP displays 2-D images. First and second polarizers PL1 and PL2 are disposed on upper and lower sides of the LC panel DP, respectively. Optical axes of the first and second polarizers PL1 and PL2 are perpendicular to each other. The backlight unit BL is disposed on a lower side of the second polarizer PL2. Namely, the second polarizer PL2 are disposed between the LC panel DP and the backlight unit BL. The lenticular lens sheet LLS is disposed on an upper side of the first polarizer PL1. Namely, the first polarizer PL1 is disposed between the LC panel DP and the lenticular lens sheet LLS. The lenticular lens sheet LLS converts the 2-D images from the LC panel DP to 3-D images.

The lenticular lens sheet LLS is fixed to the LC panel including the first and second polarizers PL1 and PL2 using a glue layer GL. Before ultraviolet light is irradiated to the glue layer GL, the glue layer GL does not have an adhesive property. However, the glue layer GL has the adhesive property due to ultraviolet light.

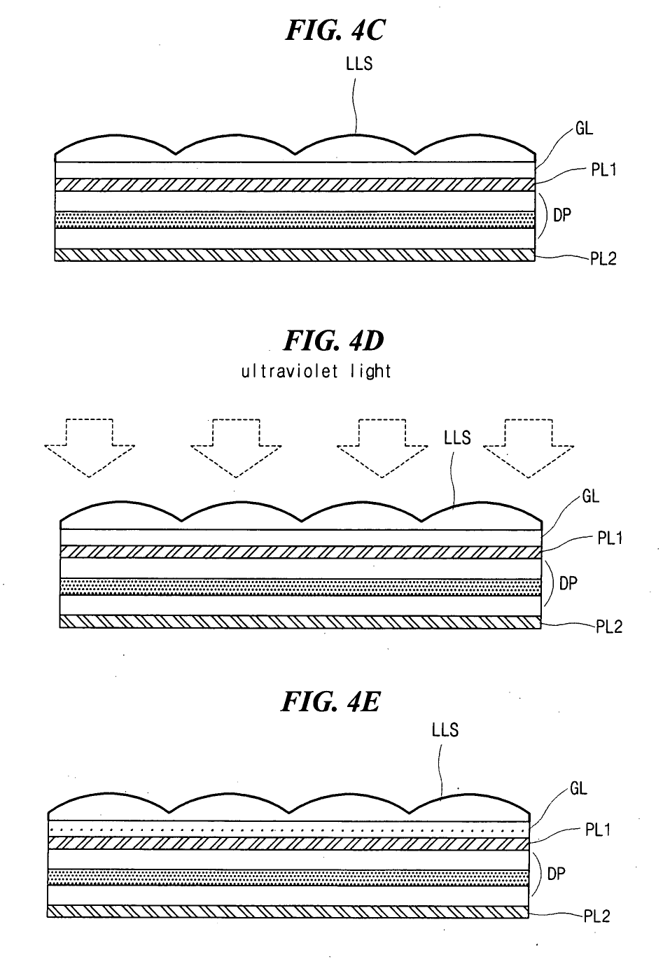

FIGS. 4A to 4E are cross-sectional views showing a process of fabricating a lenticular lens type 3-D image display device according to the present invention.

As shown in FIG. 4A, the first and second polarizers PL1 and PL2 are disposed on the upper and lower sides of the LC panel DP. At least one of the first and second polarizers PL1 and PL2 can be omitted depending on a mode of the LC panel DP.

As shown in FIG. 4B, a glue material GLM is sprayed on the first polarizer PL1 using a dispenser DI. The dispenser DI has a plurality of nozzles (not shown). The dispenser DI sprays the glue material along a length direction of the LC panel DP. The dispenser DI sprays the glue material through the plurality of nozzles during moving from one side of the LC panel DP to the other side of the LC panel DP such that a glue layer GL is formed on an entire surface of the LC panel DP, as shown in FIG. 4C.

The glue layer GL does not have an adhesive property yet. However, when exposed by ultraviolet light, the glue layer GL has the adhesive property. The glue material GLM includes one of acrylate resin, silicon, acrylate resin-silicon mixture, urethane, acrylate resin-urethane mixture, epoxy, acrylate resin-epoxy mixture, and so on. The glue material can be selected from above materials depending on an optical characteristic of the LC panel DP.

Next, the lenticular lens sheet LLS is disposed on the glue layer GL. Since the glue layer GL does not the adhesive property yet, the lenticular lens sheet LLS is not fixed to the LC panel DP. Accordingly, it is possible to extract air between the lenticular lens sheet LLS and the LC panel DP and realign the lenticular lens sheet LLS on the LC panel DP.

Next, as shown in FIG. 4D, ultraviolet light is irradiated onto the lenticular lens sheet LLS. The glue layer GL is chemically changed due to the ultraviolet light to have the adhesive property.

And then, as shown in FIG. 4D, the lenticular lens sheet LLS is fixed on the LC panel DP due to the adhesive glue layer GL. The lenticular lens type 3-D image display device according to the present invention is fabricated through the above-mentioned process.

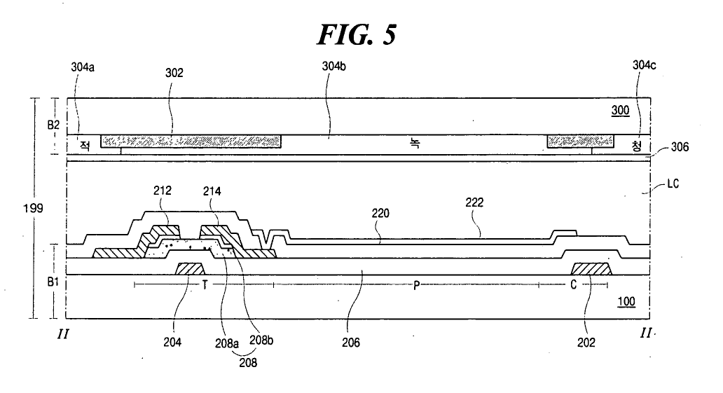

FIG. 5 is a schematic cross-sectional view showing a liquid crystal panel used for a display panel in a lenticular lens type 3-D image display device according to the present invention. The LC panel is combined with the lenticular lens sheet and displays the 2-D images.

In FIG. 5, the LC panel 199 includes a color filter substrate B2, an array substrate B1 and a liquid crystal layer LC therebetween. The color filter substrate B2 includes a black matrix 302 on a first substrate 300, color filters 304a, 304b and 304c on the black matrix 302, and a common electrode 306 on the color filters 304a, 304b and 304c. The array substrate B1, wherein a plurality of pixel regions P are defined, includes a plurality of thin film transistors T on a second substrate 100, a plurality of pixel electrodes 222, a plurality of gate lines 202 and a plurality of data lines (not shown). A plurality of thin film transistors T are arranged in a matrix form. Each thin film transistor T includes a gate electrode 204, a semiconductor layer 208 including an active layer 208a and ah ohmic contact layer 208b, a source electrode 212 and a drain electrode 214. The gate electrode 204 is formed on the second substrate 100, and the semiconductor layer 208 is disposed over the gate electrode 204. A gate insulating layer 206 is interposed between the gate electrode 204 and the semiconductor layer 208. The source and drain electrodes 212 and 214 are formed on the semiconductor layer 208 and spaced apart from each other. Each data line (not shown) is connected to the respective source electrodes 212 of the thin film transistors T of a corresponding column of the matrix form, and each gate line 202 is connected to the respective gate electrodes 204 of the thin film transistors T of a corresponding row of the matrix form. The pixel region P is defined by crossing of the gate line 202 and the data line (not shown). Each pixel electrode 222 in each pixel region P is connected to corresponding thin film transistor T. The pixel electrode 222 is formed of a transparent conductive material including indium-tin-oxide (ITO) and indium-zinc-oxide (IZO).

Each pixel region P corresponds to one of red, green and blue pixels. Moreover, one of two red pixels displays the 2-D image for right eye, and the other one of the two red pixel displays the 2-D image for left eye.

The above-mentioned LC panel is attached with the lenticular lens sheet using the glue layer to produce high quality 3-D images. Since the lenticular lens sheet is attached to the LC panel with the adhesive glue layer, it is everlasting. Moreover, since the glue material in the glue layer does not have an adhesive property before exposed to ultraviolet light, it is possible to realign the lenticular lens sheet onto the LC panel. Furthermore, it is possible to extract air between the lenticular lens sheet and the LC panel.

It will be apparent to those skilled in the art that various modifications and variations can be made in the lenticular lens array and image display device including the same of the present invention without departing from the spirit or scope of the invention. Thus, it is intended that the present invention cover the modifications and variations of this invention provided they come within the scope of the appended claims and their equivalents.

What is claimed is:

1. A lenticular lens type three-dimensional image display device, comprising:
a display panel;
a first polarizer on an upper surface of the display panel;
a glue layer uniformly formed on an entire surface of the first polarizer; and
a lenticular lens sheet on the glue layer,
wherein the glue layer has an adhesive property when exposed to an ultraviolet light.

2. The device according to claim 1, further comprising a second polarizer on a lower surface of the display panel.

3. The device according to claim 1, wherein an upper side of the lenticular lens sheet has a plurality of convex portions, and a lower side of the lenticular lens sheet has a flat surface.

4. The device according to claim 3, wherein the flat surface of the lenticular lens sheet facing the display panel.

5. The device according to claim 3, wherein the plurality of convex portions each has a half-cylindrical shape.

6. The device according to claim 1, wherein the glue layer includes one of acrylate resin, silicon, acrylate resin-silicon mixture, urethane, acrylate resin-urethane mixture, epoxy, and acrylate resin-epoxy mixture.

7. The device according to claim 1, wherein the display panel comprises:
a first substrate including a thin film transistor, a gate line, a data line and a pixel electrode, wherein the thin film transistor is formed at crossing of the gate and data lines, and the pixel electrode is connected to the thin film transistor;
a second substrate facing the first substrate and including a common electrode; and
a liquid crystal layer interposed between the first and second substrates.

8. A method of fabricating a lenticular lens type three-dimensional image display device, comprising:
uniformly forming a material layer on an entire surface of a display panel;
disposing a lenticular lens sheet on the material layer; and
irradiating an ultraviolet light onto the material layer through the lenticular lens sheet, the lenticular lens sheet fixed to the display panel.

9. The method according to claim 8, wherein the material layer has an adhesive property by the ultraviolet light.

10. The method according to claim 8, wherein the material includes one of acrylate resin, silicon, acrylate resin-silicon mixture, urethane, acrylate resin-urethane mixture, epoxy, and acrylate resin-epoxy mixture.

11. The method according to claim 8, wherein the material is coated on the display panel using a dispenser having a plurality of nozzles.

12. The method according to claim 11, wherein the dispenser scans the display panel.
